(19) United States
(12) Patent Application Publication
(10) Pub. No.: US 2012/0280588 A1
(43) Pub. Date: Nov. 8, 2012

(54) MAGNETIC ROTATIONAL DEVICE

(76) Inventor: Thomas Patrick Bryson, Brantford (CA)

(21) Appl. No.: 13/512,086

(22) PCT Filed: Nov. 26, 2010
(86) PCT No.: PCT/CA2010/001880

§ 371 Date: May 25, 2012

Related U.S. Application Data
(60) Provisional application No. 61/264,735, filed on Nov. 27, 2009.

(51) Int. Cl. H02K 21/16; H02K 21/00; H02N 11/00

(52) U.S. Cl. 310/156.25; 310/152; 74/DIG. 9

(57) ABSTRACT

A rotating device having a stator and rotor, in which paired arcs of staggered magnets are affixed to the rotor surface, such that the staggered magnets are off-set the center-line of the rotor. Stator magnets, located on the stator, are also affixed in an off-set manner. During rotation, the repulsive interaction between stator and rotor magnets is off-set the centreline of the rotor, resulting in a tangential force on the rotor, which imparts angular momentum on the rotor, thereby inducing rotation.

### TECHNICAL FIELD

The present application relates to the field of motors, and in particular, to a rotational device based on magnetic fields.

### BACKGROUND

Motors relying solely upon magnetic propulsion have been attempted in various forms for many years, and invariably fail for a number of reasons. Most “magnet only” motors can turn most of the way around a single revolution, but cannot get back to the starting point to complete the cycle, commonly referred to as the “dead spot” or “point of no return”.

Canadian Patent No. 1,164,519 (Studer) discloses a linear magnetic motor/generator that uses magnetic flux to provide mechanical motion or electrical energy. The linear magnetic motor/generator includes an axially movable actuator mechanism. Studer's device is a non-rotating linear magnetic motor/generator designed to create an axial movement.

Canadian Patent Application No. 2,549,842 (Kasheke) discloses a self-inductive electroreactive magnetic motor that includes: a stator, a rotor, magnet blocks and coils. In this invention, four aluminum rods are also introduced to run the motor; each carries a piece of steel metal attached at the end thereof close to the nearest approaching magnet with the aim to cause a reactive magnetic force. As the steel metal is brought within the nearest proximity of the magnets, an attractive force is created whereby each metal piece incites each magnet to be drawn to grab it. The forces of attraction which are thereby generated cause the rotor to spin. The device disclosed by Kasheke contains a conventional stator, rotor and coil assembly commonly found in all electrical motors, generators or turbines.

U.S. Patent Application No. 2008/0174121 (Wattenbarger), now abandoned, discloses a device capable of utilizing magnetic and gravitational forces to generate electrical energy. U.S. Patent Application No. 2009/0179432 (Wattenbarger) discloses a device similar to that of 2008/0174121, with the additional inclusion of fluid forces acting on an arm of the device, in concert with magnetic and gravitational forces. In both applications, Wattenbarger discloses an overbalanced arm and hammer assembly with magnets attached, rotating within a frame upon which more magnets are attached; the two magnets are oriented with similar poles facing. As the heavily weighted arm falls due to gravity, significant energy in the form of centrifugal force is developed through quadrants 1-2. However, during quadrants 3-4, momentum is lost as the weight tries to overcome the effects of gravity and friction, and would indeed stop rotating completely without an external force acting upon the arm. The very nature of the unbalanced arm prevents the device from achieving any appreciable speed without destroying the connecting members.

### SUMMARY

Disclosed herein is a rotating device with a useable output of work producing minimal environmental impact. Moreover, the device relies on a combination of magnetic polar attraction and repulsion, for operation. More specifically, there is provided a rotating alternate energy device that is scalable, and can be adjusted dimensionally to conform to specifications of size, space and function. The device maybe incorporated into existing electrical or mechanical systems such as a turbine, generator, motor, pump or any combination thereof, depending upon the nature of the application. Such a device is mobile, and can rotate, generate an electrical current, or create a mechanical force (or any combination thereof). In addition, the device can be used in remote locations, where access to electrical power is limited.

In addition to the foregoing attributes, electrical or mechanical output generated is renewable and causes significantly less environmental impact in comparison to devices operating on fossil fuels or devices operating on electrical power generated from coal fired generators or nuclear reactors.

A device of the present application provides a novel electrical and/or mechanical output incorporating a focused field repulsion through one or more external magnets acting upon a rotor containing staggered magnetic arrays, thereby causing the device to rotate.

The arrangement of the magnetic arrays in the present application eliminates problems associated with traditional motors having a single magnetic field encompassing the entire diameter of the device. Adjacent arcs of staggered magnets create two distinct and separate magnetic fields. By staggering the arrays in an arc a condition exists whereby the small surface of each staggered array magnet approaches an external magnet and is immediately attracted to it. The arc extends less than 360 degrees; it can extend between 145 and 270 degrees; or between 170 and 190 degrees; or about 180 degrees. Due to this arrangement, the rotation of the array causes the small surface to reduce its projection or focus in attraction mode as the larger repelling surface comes into direct influence of the flux field of the external magnet. The amount of attraction and repulsion can be manipulated based upon the structure of the array to achieve the desired result.

In one aspect, there is provided a rotating device comprising a)a rotor having a radial centreline; the rotor have one or more staggered magnetic arrays aligned along a perimeter surface of the rotor; each array consisting of a first and second arc; each arc having two or more magnets staggered along the perimeter surface of the rotor; with the first arc adjacent to the second arc, such that the first arc is substantially out of phase with the second arc, and the angular sum of the two arcs is at least 360 degrees; and b) a plurality of stator magnets external to the rotor, the stator magnets positioned to interact with each staggered magnet; where the stator magnets are affixed to a housing; wherein magnetic repulsion between each stator magnet and each staggered magnet is offline the radial centreline of the rotor.

The rotating device can have two or more arrays, each array having a transition point between adjacent arcs; wherein the transition points of successive arrays are out of phase. In addition, the stator magnets can be electromagnets timed to impart a repulsive magnetic force twice per revolution of the rotor at each transition point of a staggered magnetic array. The first arc can overlap with the second arc, and the angular sum of the two arcs is between 360 degrees and 450 degrees. In the device, each staggered magnet can be a permanent magnet, made of a rare-earth material, such as neodymium. In addition, the number of electromagnets interacting per staggered magnetic array can be between two and twelve, and can be three.

In another aspect, there is provided a rotating device comprising: a) a rotor having a radial centreline; the rotor have two or more staggered magnetic arrays aligned along a perimeter surface of the rotor; each array consisting of a first and second arc; each arc having two or more permanent magnets staggered along the perimeter surface of the rotor; with the first arc adjacent to the second arc, such that the first arc is substantially out of phase with the second arc, and the angular sum of the two arcs is at least 360 degrees; each array having a transition point between adjacent arcs; the transition points of successive arrays being out of phase; b) a plurality of electromagnets external to the rotor, the stator magnets positioned to interact with each staggered magnet; where the stator magnets are affixed to a housing; c) the number of electromagnets interacting with each staggered magnetic array is between two and twelve; d) each electromagnet is timed to impart a repulsive magnetic force twice per revolution of the rotor at each transition point of a staggered magnetic array; wherein magnetic repulsion between each electromagnet and each staggered magnet is offline the radial centreline of the rotor.

The foregoing summarizes the principal features of the application disclosed herein and some of its optional aspects. The features may be further understood by the description of the embodiments which follow. Wherever ranges of values are referenced within this specification, sub-ranges therein are intended to be included within the scope of the invention unless otherwise indicated. Where characteristics are attributed to one or another variant of the invention, unless otherwise indicated, such characteristics are intended to apply to all other variants of the invention where such characteristics are appropriate or compatible with such other variants. The embodiments described herein are intended to demonstrate the principle of the invention, and the manner of its implementation, without restricting the scope thereof.

### BRIEF DESCRIPTION OF THE DRAWINGS

FIG. 1A illustrates a first embodiment of a rotor of the present invention and FIG. 1B illustrates a conventional rotor.

FIG. 2A illustrates a conventional rotor and stator, and FIG. 2B illustrates an embodiment of a rotor and stator of the present invention.

FIGS. 3A and 3B are a planar view and a top perspective view, respectively, of a second embodiment of a rotor of the present invention.

FIG. 4 is a schematic view of the second embodiment during the repulsion phase of operation.

FIG. 5 is a schematic view of the second embodiment during the reciprocation phase of operation.

FIG. 6 is a schematic top view of FIG. 5.

FIG. 7 is perspective view of a third embodiment of the present invention.

FIG. 8 illustrates a front perspective view of the rotor and electromagnets shown in FIG. 7.

FIG. 9 illustrates a top perspective view of a pair of staggered magnets and a triplet of electromagnets shown FIG. 8.

FIG. 10 is a top planar view of the staggered magnets and electromagnets shown in FIG. 9.

### DETAILED DESCRIPTION OF PREFERRED EMBODIMENTS

This detailed description is not intended to represent the only form in which the invention may be assembled, operated or utilized. This description serves to illustrate the assembly and subsequent operation of the device. It should be noted and understood that the assembly, operation, actuation and inter-relation of the various parts and subsequent processes may be achieved by different embodiments than that described herein, and although such departure may produce similar results, they are also intended to be encompassed within the scope of the claims.

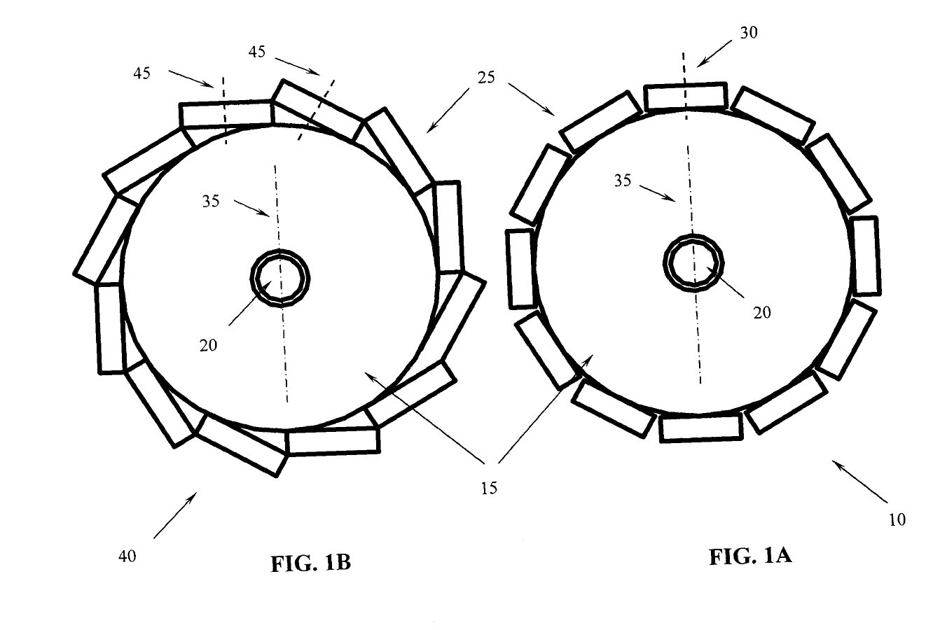

FIG. 1A illustrates a conventional magnet rotor (10), which includes a central cylinder (15) with a central aperture (20) for a shaft (not shown), and a plurality of magnets (25) on the perimeter surface of the cylinder (15). The magnets (25) are placed symmetrically along the surface, in that a line normal to the mid-point of each magnet (30) lies along the radial center-line (35) of the cylinder (15).

FIG. 1B illustrates a first embodiment of a magnet rotor (40), which includes a central cylinder (15) with a central aperture (20) for a shaft (not shown), and a plurality of magnets (25) on the perimeter surface of the cylinder (15). Unlike the conventional rotor (10), the magnets (25) are not placed symmetrically along the surface of the cylinder, but rather, in a “pin-wheel” formation. A line normal to the mid-point of each magnet (45) does not lie along the radial center-line (35) of the cylinder (15). That is, the rotor magnets (25) are off-set from the radial center-line (35).

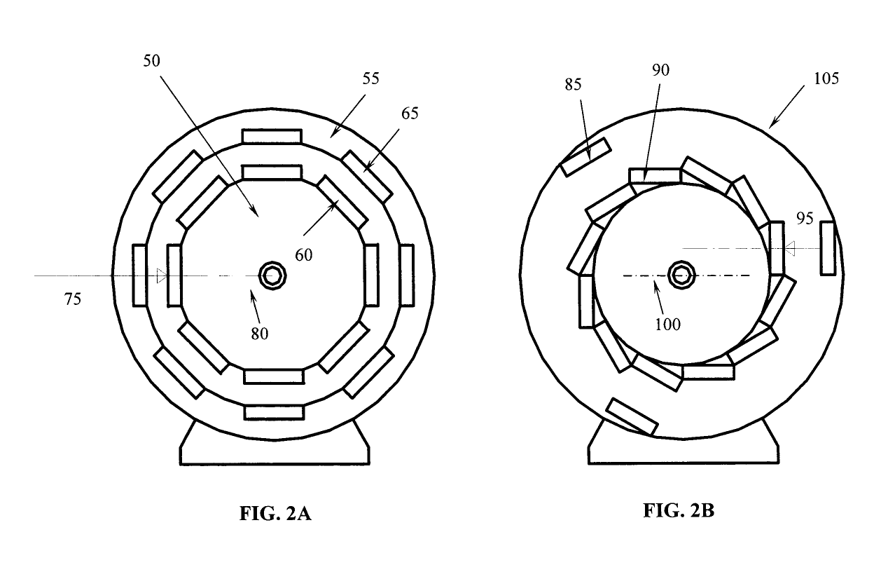

The off-set of the rotor magnets plays a key role in the magnetic dynamics of the interaction between rotor and stator magnets, as shown in FIGS. 2A and 2B.

FIG. 2A illustrates a conventional rotor (50) and stator (55), in which the rotor magnets (60) and stator magnets (65) are symmetrically aligned along the respective surface of the rotor and stator (as in the symmetrical placements of the rotor magnets (25) shown in FIG. 1A). FIG. 2A shows a “snap-shot” during rotation, in which the each stator magnet (65) faces a rotor magnet (70). Each magnet surface has the same polarity, resulting in a repulsive force between the two magnets. The direction of the radial force is shown by the arrow (75); it is clearly along the rotor center-line (80). Since every stator-rotor magnet pair has a radial magnetic repulsive interaction, there is no tangential force to impart angular momentum to the rotor at this point, in which case the rotor-stator combination experiences resistance to rotation. This resistance is repeated during the rotation every time there is stator-rotor repulsive magnetic interaction between the face of a stator magnet and a rotor magnet.

On the other hand, in FIG. 2B, the repulsive magnetic interaction between stator magnets (85) and rotor magnets (90) is off-center the rotor central-line (100), as shown by the arrow (95). This is due to the off-set alignment of both the rotor magnets (90) and the stator magnets (85) on the stator (105). Since the repulsive magnetic interaction (95) is off-center, it has a radial component and a tangential component along the rotor cylindrical surface; the resulting tangential force imparts angular momentum to the rotor. This “kick” of angular momentum occurs every time there is stator-rotor repulsive magnetic interaction between the face of a stator magnet and a rotor magnet, due to the off-set alignment of the rotor and stator magnets.

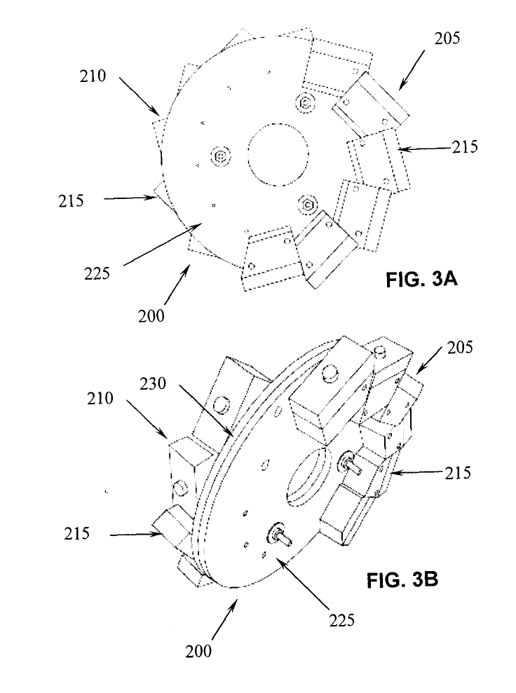

FIGS. 3A and 3B illustrate details of a second embodiment of a rotor (200), in which two arcs (205, 210) of staggered magnets (215) are each aligned along the surface of a cylindrical ring (225, 230). While rings (225, 230) are shown, one singular cylinder can be used, with one arc of staggered magnets aligned on the perimeter of the planar surface of the cylinder, and a second arc of staggered magnets aligned adjacent to the first arc, along a perimeter of the planar surface of the cylinder. Alternatively, the staggered magnets can be affixed to the surface of the cylinder in a conventional manner known to an ordinary worker skilled in the art.

While rectangular magnets are shown, it is understood that the permanent magnets on the rotor can have any shape. These include, but are not limited to, button-shaped, square, triangular, and the like.

The number of staggered magnets per arc can vary in number, so long as a staggered arrangement of magnets exists along the perimeter of the cylinder. While six staggered magnets are shown per arc, it is understood that the number of staggered magnets per arc can be at a minimum of two. While FIGS. 3A and 3B illustrate the number of staggered magnets per arc as six, the number of staggered magnets in each respective arc can be equal or unequal. Each arc (205, 210) is separate from the other and does not encompass the entire diameter of the power unit. While FIGS. 3A and 3B illustrate a pair of arcs, it is understood that a rotor can use more than one pair of arcs of staggered magnets.

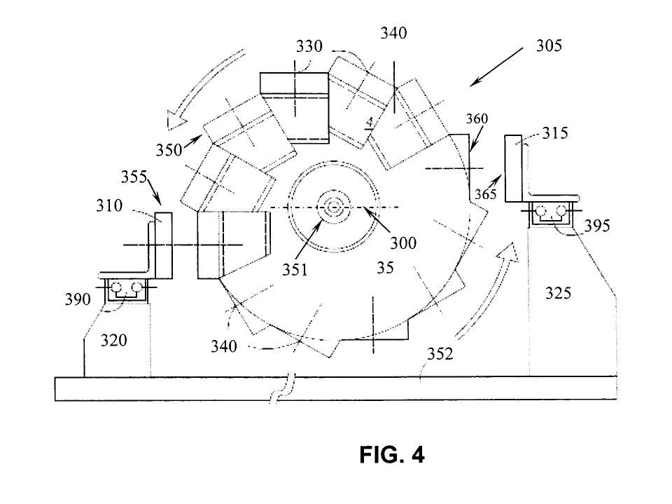

FIG. 4 illustrates a schematic of interaction between rotor magnets and a stator magnet during the “repulsion phase”. The repulsion phase initiates rotation of approximately 180 degrees, using attraction of the small approaching magnetic surfaces and repulsion of the large surfaces of the magnets above and below the rotor centreline (300) to continue the rotation in the desired direction.

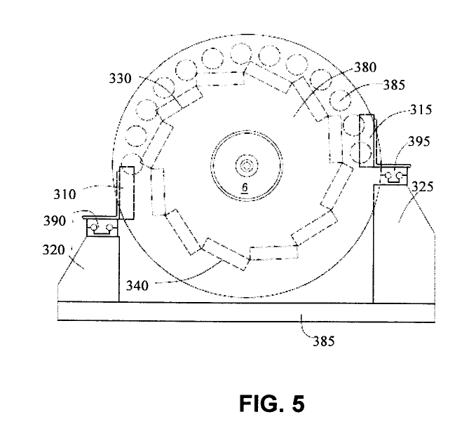

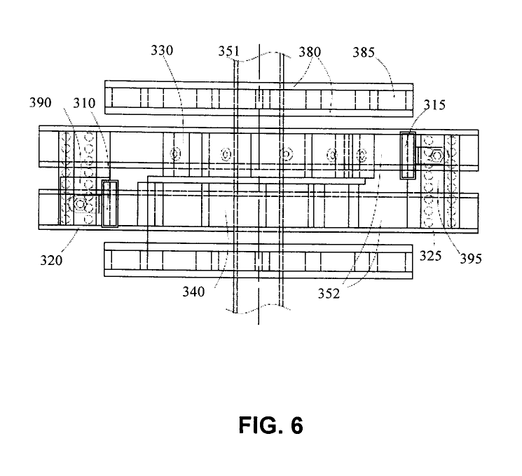

For clarity, surrounding housing of the rotor (305) is not shown. Front and rear shuttle magnets (310, 315) are mounted on respective support mechanisms (320, 325). Each shuttle magnet (310, 315) also includes a sliding track (390, 395), which is discussed in relation to FIGS. 5 and 6 below. One shuttle magnet (310) is below the centerline (300), while the other shuttle magnet (315) is above the centreline (300).

A first series of staggered magnets (330) are mounted on one side of a mounting plate (335), while second series of staggered magnets (340) are mounted on the other side of the plate (335). In this embodiment, the staggered magnets (330, 340) are mounted via magnet holding blocks (345), made of a lightweight non-magnetic material (for example, but not limited to, aluminum). There are other suitable ways of affixing the staggered magnets onto a rotating cylinder (or mounting plate), such as using epoxy or other similar affixing means. In this embodiment, the magnet holding blocks (345) are mounted with a 30 degree offset from the centerline (300), with six magnet holding blocks on each side of the rotor. Other arrangements are possible, with different the staggered magnetic blocks mounted with a different angular offset from the centerline, and a different number of staggered magnets per arc. The rotor (305) can include a conductive bearing housing and axle (351). Shown are tracks (352) for an application shown in FIG. 5. In addition, shuttle magnet (310) faces the staggered magnetic array (330), while shuttle magnet (315) faces the array of staggered magnets (340). That is, shuttle magnets (310) and (315) are not in the same vertical plane.

Operation is initiated by advancing the shuttle magnets (310, 315) horizontally along a slide system (not shown) towards the rotor (305) until each shuttle magnet (310, 315) is introduced into the magnetic flux field created by the array of staggered magnets (330, 340).

The direction of rotation is shown by the large arrows. As the small surface (350) of staggered magnet (330) approaches the small surface (355) of the shuttle magnet (310), the two are in attraction mode, as the magnetic polarities of the respective surfaces are opposite. As the surfaces rotate towards each other, the area of attraction on each staggered magnet (330) is reduced as the next magnet is drawn into the attraction of the shuttle magnet (310). Similarly, attraction forces between the rear shuttle magnet (315) and the staggered magnets (340) cause the latter to be to be “drawn up”.

After the attraction phase of the small surfaces, the larger surface (360) of the staggered magnets (340) are introduced to the larger surface (365) of the shuttle magnet (315). This also applies to the shuttle magnet (310) and staggered magnets (330). This interaction is repulsive since both large surfaces have the same polarity.

As seen in FIG. 4, the repulsion magnet (310) which is opposite the staggered magnet (330), is in repulsion mode, with the repulsive interaction aligned below the centreline (300) of the rotor. This offline repulsive force has a tangential component (as shown in FIG. 2B), which continues to propel the assembly in the same rotational direction. Simultaneously, the shuttle repulsion magnet (315) which is opposite the staggered magnet (340), produces a repulsive magnetic force which is aligned above the centreline (300), which reinforces the rotation in the same direction.

Experiments have shown that magnetic arrays that are radially positioned around the rotor (and not staggered like the invention) will invariably stop rotating as the repelling force is directly in line with the centreline and will not induce rotation. By ensuring the repelling force is applied when the assembly is past the centreline (300), the force can induce rotation as the path of least resistance.

At the conclusion of the repulsion cycle (approximately 180′ rotation), the front (310) and rear shuttle magnets (315) are in a neutral, non-repulsive phase, in that neither faces an arc of staggered magnets. In order to continue any further rotation, the shuttle magnets (310, 315) will need to move to the other side of the rotor (from their respective initial positions) in order to engage the opposite staggered array to provide uniform propulsion and keep the assembly rotating. This can be achieved by any number of means.

One embodiment of “forcing” the shuttle magnets (310, 315) into a position where each engages the opposite staggered array is shown in FIG. 5, which illustrates a schematic view. The reference numerals used therein are identical to those of FIG. 4. Magnetic thrust plates are positioned on the conductive housing to deliver a thrust of sufficient quantity to cause the movement of the shuttle magnets (310, 315). In FIG. 5, only one magnetic thrust plate (380) is shown. There is another thrust plate on the opposite side of the mounting plate. The shuttle magnets (310, 315) interact with the magnetic thrust plates, and translate to the opposite side of the along linear slides (390, 395), and maintain this position for approximately 180° of rotor rotation to ensure the maximum amount of repulsion force between the repulsion magnets and staggered magnets to induce rotation.

In FIG. 5 each magnetic thrust plate (380) has magnets (385) encapsulated within the construction of the plates near the perimeter and continuing in radial fashion for about 180°. The magnets can have any shape (for example, but not limited to, button, triangular, rectangular, square, etc.), and are constructed of conventional magnetic materials, such as rare-earth material, including neodymium (or similar materials). Each magnetic thrust plate (380) rotates in a track (352)

The reciprocating phase is initiated by the rotation of the magnetic thrust plates (380) engaging the side magnetic field of the shuttle magnets (310, 315) causing each shuttle magnet to reciprocate due to the repulsive forces from engagement with the magnetic thrust plates. The magnets (385) on the thrust plates have duration of approximately 180 degrees to ensure the shuttle magnets are exposed to the repelling field of the staggered array.

The embodiment shown in FIG. 5 uses a non-contact means of positioning the shuttle magnet; however, a similarly effective means can be achieved using radial cams acting directly upon the reciprocating member, or electro-magnets timed to deliver a pulse at the appropriate time.

FIG. 6 illustrates a top schematic view of the embodiment shown in FIGS. 4 and 5. The reference numerals used therein are identical to those of FIGS. 4 and 5. This view shows the effect of the reciprocating phase. Both shuttle magnets (310, 315) have been aligned in the path of the staggered array magnets (330, 340) by the repelling force of the encapsulated neodymium magnets (385), contained in the magnetic thrust plates (380, 381) and are ready for the repelling phase of approximately 180 degrees of rotor rotation, before the opposite action will cause the shuttles to reciprocate in the opposite direction.

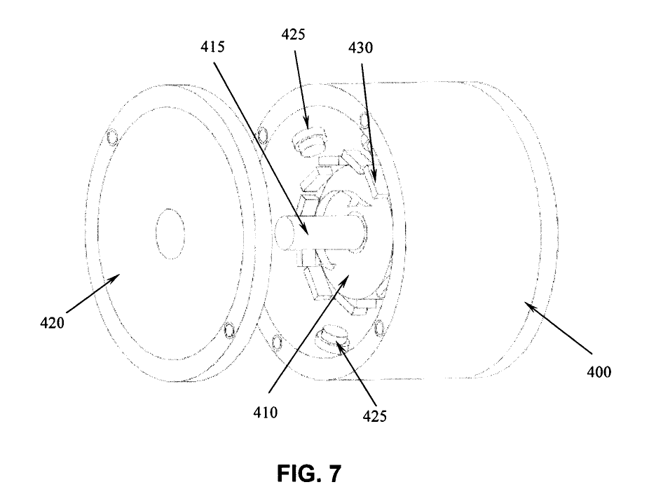

The principles shown in FIGS. 4-6 are also used in the embodiment shown in FIGS. 7-10.

FIG. 7 is perspective view of a third embodiment of the present invention, showing a stator (400), rotor (410), and axle (415), along with an endcap (420) which has been removed to show the interior of the stator (400) and the rotor (410). The stator (400) has mounted on its inner surface a number of electromagnets (425), which are mounted in off-set manner as described in FIG. 2. Although button-shaped electromagnets are shown, it is understood that the stator magnets can have other shapes, such as square, rectangular, triangular, and the like. The rotor includes permanent magnets (430) mounted on the surface of the rotor (410) in an off-set manner as described in FIG. 2. The shape of the rotor magnets is not restricted to that shown in FIG. 7. Similarly, the respective number of stator magnets and rotor magnets can vary.

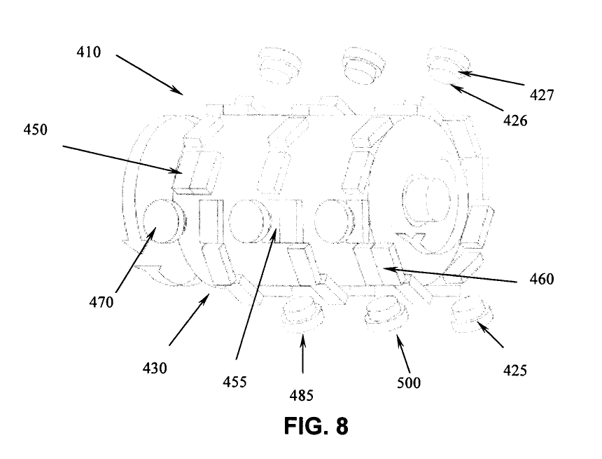

FIG. 8 illustrates a front perspective view of the rotor (430) and electromagnets (425) shown in FIG. 7 (with the housing of the stator removed). In this embodiment, there are three arrays of staggered magnets (430); each array consisting of a pair of arcs of staggered magnets. Each arc consists of six staggered magnets, and the arcs overlap at each end by one magnet, resulting in a transition point (450) of two permanent magnets. Furthermore, each successive array is out of phase with its predecessor, in that the transition point of one array is not aligned with the transition point of the next array. That is, transition points (450), (455) and (460) are not aligned along the surface of the rotor.

Each array (or arc pairs) of staggered magnets interacts with a triplet of electromagnets. The surface area of the face (426) of each electromagnet is wide enough to encompass the transition blocks of a given arc pair of staggered magnets. The electromagnet includes a portion (427) around which are coils (not shown).

The direction of rotation of the rotor (410) is indicated by the large arrows. The electromagnets for a given array, are timed to pulse at the moment the transition blocks pass in front of the electromagnet. For example, when transition point (450) passes in front of electromagnet (470), the polarity of electromagnet (470) is switched on so as to repel the magnets comprising transition point (450). As shown in FIG. 2, the repulsion force is off-center, resulting in a tangential force that imparts angular momentum to the rotor. Transition point (455), consisting of two staggered magnets, is facing an electromagnet (485) and receiving a repulsive force, while transition point (460) has just passed electromagnet (500), and received the magnetic repulsive force.

As the rotor rotates, each electromagnet is timed to provide a repulsive magnetic pulse as a transition point passes the electromagnet. The electronic mechanism used to time the electromagnets is not shown. However, standard mechanisms known in the art can be used.

The periodic pulsing of electromagnets induces rotation of the rotor. The number of magnetic arrays can vary, as can the number of electromagnets for a given magnetic array. Furthermore, the arcs of a given array need not overlap (that is, the transition point need not have double blocks of permanent magnets). Similarly, successive arrays can have transition points aligned, although experimental results show out-of-phase transition points provide for a smoother torque.

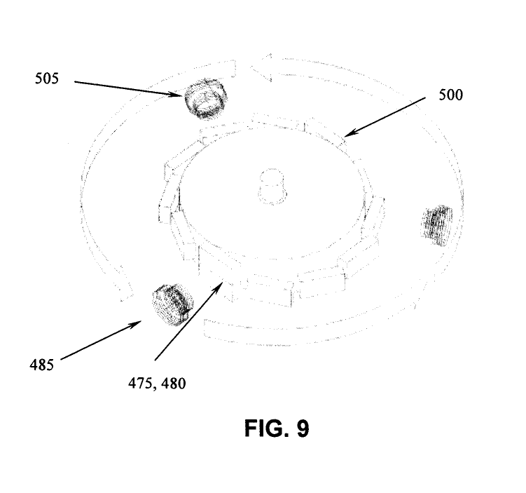

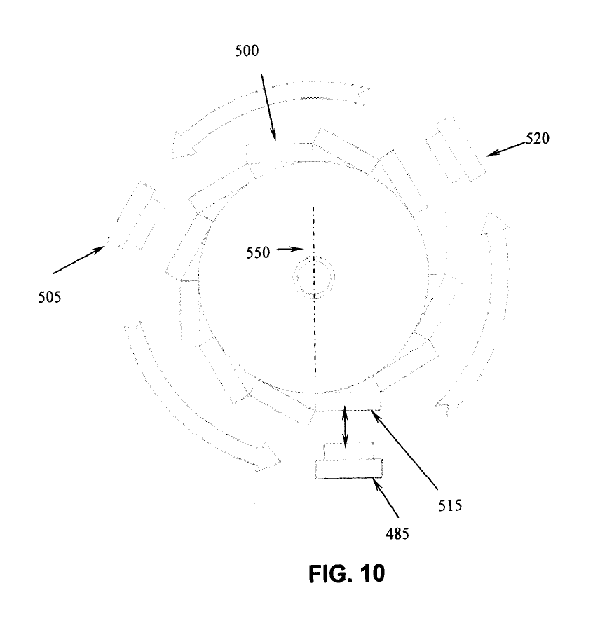

FIG. 9 illustrates a top perspective view of a pair of staggered magnet arcs and a triplet of electromagnets shown FIG. 8, along with the direction of rotation. Transition magnetic blocks (475, 480) are facing an electromagnet (485). The second transition point (500) is about to approach electromagnet (505), which will pulse (i.e. have the same polarity as the rotor magnet) when it faces the transition point. This is further illustrated in FIG. 10, which shows the magnetic repulsion between the electromagnet (485) and transition point (515) (made of blocks (475, 480) which are not visible in FIG. 10), which is offset the rotor centerline (550), which imparts angular momentum in the direction of the arrows. As rotation proceeds, the transition point (500) will pass electromagnet (505), at which point, the pulsing of the electromagnet (505) will result in magnetic repulsion that is offset the centerline, which in turn, induces rotation. Thereafter, transition point (515) will interact with electromagnet (520) which is pulsed just as transition point (515) passes in front thereof. The cycle is then repeated.

It is contemplated that the rotational device can be used in a variety of potential applications due to the ability of the device to be scaled proportionately. More specifically, there is provided a rotating alternate energy device that is scalable, and can be adjusted dimensionally to conform to specifications of size, space and function. The device may be incorporated into existing electrical or mechanical systems as a turbine, generator, motor, pump or any combination of them depending upon the nature of the application, and/or seamlessly connect to a variety of green generation devices.

It is further contemplated that the a small scale version can be used in remote locations in concert with small photovoltaic solar cells to deliver a continuous supply of electricity to a cellular repeater station or microwave towers. Such hybridization of the device to include inputs from other green generating devices will further expand its adoption and dramatically increase the potential uses of it.

In addition, the rotation device can be used to produce a passive onboard power current for electrical vehicle batteries or fuel cells when used in concert with a flexible roof mounted photovoltaic membrane to extend the potential range of these vehicles and provide a means of replenishing electrical levels when the vehicle is parked and not able to be plugged into a re-charging dock.

The device can also be used in a trailer-able form in varying sizes to provide emergency power in disaster zones, forward deployment military troop support, or as a portable power pack that could be towed to a remote location or rural abode void of conventional power supply.

In a large-scale version, the device can be used in place of existing coal fired generators to spin turbines connected to existing power infrastructure as a means of generating green, renewable energy.

The foregoing has constituted a description of specific embodiments showing how the invention may be applied and put into use. These embodiments are only exemplary, and are not intended to restrict the scope of the claims.

1. A rotating device for use in an electrical or mechanical system, said rotating device comprising:
a) a rotor having a radial centreline; the rotor having one or more staggered magnetic arrays aligned along a perimeter surface of the rotor; each array consisting of a first and second arc; each arc having two or more magnets staggered along the perimeter surface of the rotor; with the first arc in a first plane, the second arc in a second plane, the first plane being adjacent to the second plane, such that the first arc is substantially out of phase with the second arc, and the angular sum of the two arcs is at least 360 degrees; and
b) a plurality of stator magnets external to the rotor, the stator magnets positioned to interact with each staggered magnet; where the stator magnets are affixed to a housing; wherein: magnetic repulsion between each stator magnet and each staggered magnet is offline the radial centreline of the rotor.

2. The rotating device of claim 1 having two or more arrays, each array having a transition point between adjacent arcs; wherein the transition points of successive arrays are out of phase.

3. The rotating device of claim 1, wherein the stator magnets are electromagnets.

4. The rotating device of claim 3, wherein each electromagnet is timed to impart a repulsive magnetic force twice per revolution of the rotor at each transition point of a staggered magnetic array.

5. The rotating device of claim 1, wherein the first arc overlaps with the second arc, and the angular sum of the two arcs is between 360 degrees and 450 degrees.

6. The rotating device of claim 1, wherein each staggered magnet is a permanent magnet.

7. The rotating device of claim 6, wherein the permanent magnet is made of a rare-earth material.

8. The device of claim 1, wherein the number of electromagnets interacting per staggered magnetic array is between two and twelve.

9. The device of claim 8, wherein the number of electromagnets interacting per staggered magnetic array is three.

10. The rotating device of claim 1, wherein said electrical or mechanical system is selected from the group consisting of a motor, a windmill, generator and a turbine.

11. A rotating device for use in an electrical or mechanical system, said rotating device comprising:
a) a rotor having a radial centreline; the rotor having two or more staggered magnetic arrays aligned along a perimeter surface of the rotor; each array consisting of a first and second arc;
b) each arc having two or more permanent magnets staggered along the perimeter surface of the rotor; with the first arc in a first plane, the second arc in a second plane, the first plane being adjacent to the second plane, such that the first arc is substantially out of phase with the second arc, and the angular sum of the two arcs is at least 360 degrees;
c) each array having a transition point between adjacent arcs; the transition points of successive arrays being out of phase;
d) a plurality of electromagnets external to the rotor, the electromagnets positioned to interact with each staggered magnet; where the electromagnets are affixed to a housing;
e) the number of electromagnets interacting with each staggered magnetic array is between two and twelve; and
f) each electromagnet is timed to impart a repulsive magnetic force twice per revolution of the rotor at each transition point of a staggered magnetic array;
wherein magnetic repulsion between each electromagnet and each staggered magnet is offline the radial centreline of the rotor.

12. The rotating device of claim 11, wherein the permanent magnet is made of a rare-earth material.

13. The device of claim 11, wherein the number of electromagnets interacting per staggered magnetic array is three.

14. The device of claim 1, wherein the number of staggered magnetic arrays is between two and twelve.

15. The rotating device of claim 1, used for generation of mechanical or electrical power.

16. The rotating device of claim 1, wherein said electrical or mechanical system is selected from the group consisting of a motor, a windmill, generator and a turbine.
